(19) United States
(12) Patent Application Publication
(10) Pub. No.: US 2024/0160929 A1
(43) Pub. Date: May 16, 2024

(54) DEVICE FOR TRAINING AND MANAGING A VISUAL SCENE GRAPH MODEL AND CONTROL METHOD THEREOF

(71) Applicant: LG ELECTRONICS INC., Seoul (KR)

(72) Inventors: Sen Jia, Toronto (CA); Homa Fashandi, Toronto (CA)

(73) Assignee: LG ELECTRONICS INC., Seoul (KR)

(21) Appl. No.: 18/507,916

(22) Filed: Nov. 13, 2023

Related U.S. Application Data
(60) Provisional application No. 63/424,457, filed on Nov. 10, 2022.

(51) Int. Cl. G06N 3/08; G06N 3/042

(52) U.S. Cl. CPC G06N 3/08; G06N 3/042

(57) ABSTRACT

A method for controlling a device to manage a visual scene graph model can include obtaining, via a processor in the device, a first dataset; obtaining, via the processor, a second data set different from the first dataset, the second dataset including one or more of a causal relation or an intention relation; combining, via the processor, the first dataset and the second dataset to generate a combined dataset. Also, the method can further include applying a knowledge embedding function to the combined dataset to generate learned common sense knowledge embeddings; and training a visual scene graph model based on the learned common sense knowledge embeddings to generate a trained visual scene graph model. Further, the method can include executing a function based on an output of the trained visual scene graph model. The device can include at least one of a smart television, a mobile phone or a robot.

### CROSS-REFERENCE TO RELATED APPLICATIONS

This non-provisional application claims priority under 35 U.S.C. § 119(e) to U.S. Provisional Application No. 63/424,457, filed on Nov. 10, 2022, the entirety of which is hereby expressly incorporated by reference into the present application.

### BACKGROUND

### Field

The present disclosure relates to a device and method of training and managing a visual scene graph model to improve performance while better accounting for rare cases and reducing long tail bias issues, in the field of artificial intelligence (AI). Further, the device and method can use causal relationships for de-biasing a visual scene graph. Particularly, the method can train a visual scene graph model with common sense knowledge graph embeddings and apply the trained visual scene graph model to direct or focus one or more functions or actions to yield better results in a more efficient manner in the AI field.

### Discussion of the Related Art

A visual scene graph (VSG) is a structured representation of the visual content of an image or video. It captures the objects, relationships, and attributes present in the scene, providing a semantic understanding of the visual world. VSGs are often constructed through a process of annotation, where humans manually identify and label the objects, relationships, and attributes in an image or video. This annotation process is often time-consuming and requires expertise in visual understanding and scene interpretation.

The Long-tail distribution is a significant challenge in the realm of visual scene graph (VSG) generation. This phenomenon arises from the skewed distribution of relationships in natural scenes, where a small number of frequent relationships dominate the majority of occurrences, while a vast number of infrequent relationships appear only rarely.

For example, consider the relationships between objects in a typical indoor scene. Common relationships, such as “person sitting on chair” or “laptop on table,” are observed frequently in everyday life. These frequently occurring relationships form the “head” of the distribution. On the other hand, rare relationships, such as “person riding an elephant” or “cat chasing a mouse,” are encountered much less frequently. These infrequent relationships form the “tail” of the distribution.

The Long-tail distribution poses a significant challenge for various machine learning tasks, particularly with regards to VSG generation. Certain categories are prevalent in the real world, such as cats and dogs, for which substantial data can be readily gathered. Conversely, rare categories, such as armadillos and elephants, are less represented due to their scarcity, resulting in relatively limited data available for training. Consequently, the collected data may be imbalanced, leading to challenges in constructing a dataset for training that ensures the model performs equally well across all categories.

In addition, VSG models tend to overfit to the frequently occurring relationships, leading to poor performance on the rare situations. This issue is further exacerbated by the inherent subjectivity in the annotation process of VSGs. For example, when humans are describing a scene to generate ground-truth data, they tend to focus on obvious and salient relationships, often overlooking or omitting the less frequent ones or inherent/common sense relationships that are present in the scene. This bias in the ground-truth data further reinforces the dominance of the head of the distribution, making it even more challenging for models to learn the rare relationships.

For example, when presented with a natural input image, humans tend to describe the image based on obvious or confident cues, such as “<laptop-on-table>” or “<table-behind-man>.” In contrast, less salient or less notable relationships, such as “<table-made-of-wood>” or “<father-and-son>,” are often overlooked or omitted from the description due to their subtlety or the lack of visual cues in the image. For object classification, the imbalance arises from the availability of data in the real world. For VSGs, this imbalance is further exacerbated by human bias in the ground-truth data, as certain categories are less noticeable to humans or deemed too obvious and inherent which leads to them being ignored. As a consequence, the trained VSG model may not perform equally well across all categories (e.g., is more biased toward the “head” of the distribution).

Accordingly, there is a need for trained visual scene graph model that can improve performance while better accounting for rare cases and reducing long tail bias issues.

### SUMMARY OF THE DISCLOSURE

The present disclosure has been made in view of the above problems and it is an object of the present disclosure to provide a device and method that can better train a VSG model while better accounting for rare cases and reducing long tail bias issues.

It is another object of the present disclosure to provide a method and device that can train a visual scene graph model with common sense knowledge graph embeddings and apply the trained visual scene graph model to execute or control one or more functions or actions to yield better results in a more efficient manner.

An object of the present disclosure is to provide a method that includes obtaining, via a processor in the device, a first dataset; obtaining, via the processor, a second data set different from the first dataset, the second dataset including one or more of a causal relation or an intention relation; combining, via the processor, the first dataset and the second dataset to generate a combined dataset; applying, via the processor, a knowledge embedding function to the combined dataset to generate learned common sense knowledge embeddings; and training, via the processor, a visual scene graph model based on the learned common sense knowledge embeddings to generate a trained visual scene graph model.

Another object of the present disclosure is to provide a method that includes merging the first dataset and the second dataset to generate a merged dataset; and shuffling entries in the merged dataset to generate the combined dataset.

Another object of the present disclosure is to provide a method, in which the first dataset includes a first group of triplets having a format that includes a subject, a relation and an object, the first group of triplets indicating spatial relationships, the second dataset includes a second group of triplets having a format that includes a subject, a relation and an object, the second group of triplets indicating causal relationships or intention relationships.

Yet another object of the present disclosure is to provide a method that includes representing both subjects and objects within the combined dataset as entities; and representing the entities and relations as at least one complex vector, in which the at least one complex vector has a dimension K.

Another object of the present disclosure is to provide a method, in which the at least one complex vector is included in a complex matrix of entities denoted as E, the complex matrix E includes a real part ER represented by a first n by K matrix, the complex matrix E includes an imaginary part EI represented by a second n by K matrix, a complex matrix of relations denoted as R includes a real part RR represented by a first r by K matrix, and the complex matrix R includes an imaginary part RI represented by a second r by K matrix.

Another object of the present disclosure is to provide a method that includes computing a score on the complex matrix E and the complex matrix R according to equation: score=<RR(relation), ER(subject), ER(object)>+<RR(relation), EI(subject), EI(object)>+<RI(relation), ER(subject), EI(object)>−<RI(relation), EI(subject), ER(object)>, in which the RR(relation) represents a real part of an embedding vector for a given relation, the ER(subject) and the ER(object) represent real parts of embedding vectors for subject and object entities, respectively, and the EI(subject) and the ER(object) represent imaginary parts of embedding vectors for the subject and object entities, respectively.

Another object of the present disclosure is to provide a method that includes executing a function based on the trained visual scene graph.

Another object of the present disclosure is to provide a device including a memory configured to store one or more datasets; and a controller configured to obtain a first dataset, obtain a second data set different from the first dataset, the second dataset including one or more of a causal relation or an intention relation, combine the first dataset and the second dataset to generate a combined dataset, apply a knowledge embedding function to the combined dataset to generate learned common sense knowledge embeddings, and train a visual scene graph model based on the learned common sense knowledge embeddings to generate a trained visual scene graph model.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example of visual scene graph (VSG) data according to an embodiment of the present disclosure.

FIG. 5 illustrates a flow chart of a method according to an embodiment of the present disclosure.

FIG. 6 illustrates a flow chart of a method an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

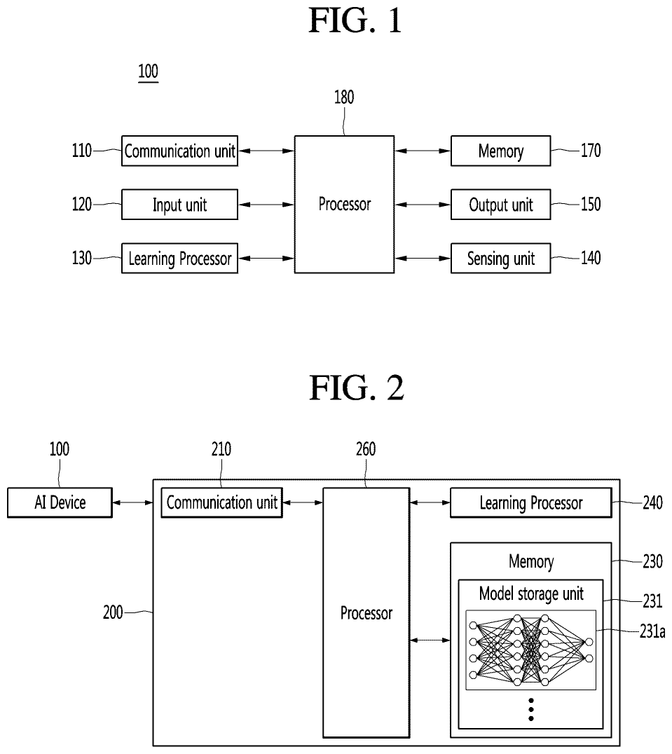

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

The communication unit 110 (e.g., communication interface or transceiver) can transmit and receive data to and from external devices such as other AI devices 100a to 100e and the AI server 200 by using wire/wireless communication technology. For example, the communication unit 110 can transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to an infer result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can execute a visual saliency prediction model. The visual saliency prediction model can predict which regions of an image or scene a person will focus. For example, the visual saliency prediction model can generate a type of heat map indicating where viewers are likely to look or eye tracking patterns.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire intention information for the user input and can determine the user's requirements based on the acquired intention information.

The processor 180 can acquire the intention information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including the operation contents of the AI apparatus 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server connected to a robot according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in memory 230.

The processor 260 can infer the result value for new input data by using the learning model and can generate a response or a control command based on the inferred result value.

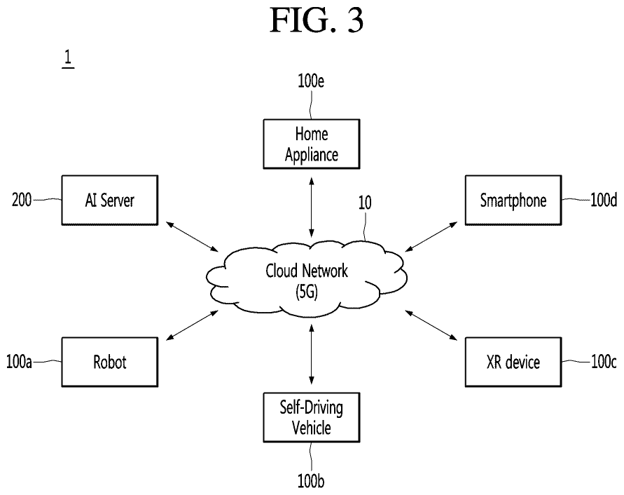

FIG. 3 illustrates an AI system 1 including a robot according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the learning model to the AI devices 100a to 100e.

At this time, the AI server 200 can receive input data from the AI devices 100a to 100e, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

The robot 100a, to which the AI technology is applied, can be implemented as a guide robot, a carrying robot, a cleaning robot, a wearable robot, an entertainment robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the learning model, and can determine the operation by using the recognized surrounding information or object information. The learning model can be learned directly from the robot 100a or can be learned from an external device such as the AI server 200.

At this time, the robot 100a can perform the operation by generating the result by directly using the learning model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

At this time, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle.

According to an embodiment, the AI device 100 can execute a function or action based on a trained visual scene graph (VSG) model. The trained VSG model is generated so that it can provide improved performance while better accounting for rare cases and reducing long tail bias issues. Further, the AI device 100 can execute a function or action based on an output of the trained VSG model.

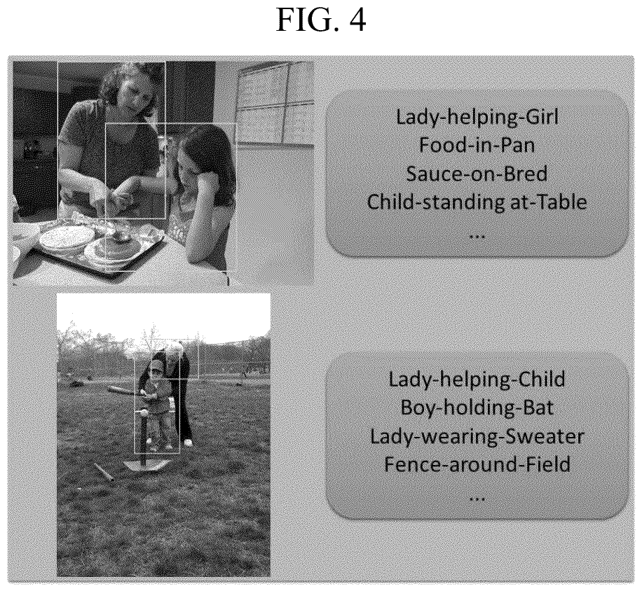

FIG. 4 illustrates an example of visual scene graph (VSG) data according to an embodiment of the present disclosure.

According to an embodiment, a visual scene graph (VSG) is a structured representation of the visual content of an image or video. The VSG can capture the objects, relationships, and attributes present in the scene, providing a semantic understanding of the visual world.

For example, the VSG data can be comprised of triplets including three elements including a subject representing an individual entity present in the scene, such as people, animals, objects, and landmarks (e.g., a person, place or thing), a relationship capturing the spatial or semantic connections between objects, such as “is on top of,” “is next to,” or “is holding,” and an object (e.g., a person, place or thing). Also, the VSG data can include attributes describing the properties of objects, such as color, shape, size, and material.

According to an embodiment, a visual scene graph (VSG) can be applied to various tasks, such as image captioning (e.g., generating natural language descriptions of images using the semantic information encoded in VSGs), visual question answering (e.g., answering questions about the content of images based on the understanding of objects, relationships, and attributes captured in VSGs), visual scene understanding (e.g., analyzing and interpreting complex visual scenes, enabling tasks like object detection, image segmentation, and scene recognition), visual grounding (e.g., linking natural language descriptions to their corresponding visual representations in images or videos), and visual commonsense reasoning (e.g., understanding and reasoning about the relationships between objects and their attributes in visual scenes, enabling tasks like anomaly detection and visual commonsense question answering), but embodiments are not limited thereto.

According to an embodiment, the AI device 100 can build a tailored CK embedding to address long-tail issues in VSG models.

Referring to FIG. 4, human annotations can have a tendency to prioritize the labeling of “obvious” relationships, such as spatial relationships and locations. While interactions between two individuals, such as “lady-helping-child,” are infrequently mentioned, symmetrical relationships like family relationships (e.g., mother, daughter, son, etc.) are often absent from visual data.

According to an embodiment, causal relationships and family relationships can be used to develop improved embeddings for VSG generation. For example, a knowledge graph embedding (KGE) model can also be used on data sets for generating improved embeddings for VSG generation, according to an embodiment.

According to an embodiment, a KGE model is a type of machine learning model that learns to represent entities and relationships in a knowledge graph as vectors in a vector space. In other words, it learns to encode the meaning of entities and relationships into numerical representations. This allows the model to reason about the knowledge in the knowledge graph and perform tasks such as link prediction, entity classification, and question answering.

For example, the knowledge graph can include triplets having a subject, a predicate and an object (e.g., John, is-a, person; John, lives-in, Toronto; Toronto, is-a, city; Toronto, is-located-in, Canada, etc.). In this example, “John” is a person who lives in Toronto, which is a city located in Canada. The KGE model can learn to represent these entities and relationships as vectors. For example, the vector representation for “John” can be [0.1, 0.2, 0.3], but embodiments are not limited thereto.

Further in this example, once the KGE model has learned the vector representations for the entities and relationships, it can be used to perform tasks such as link prediction.

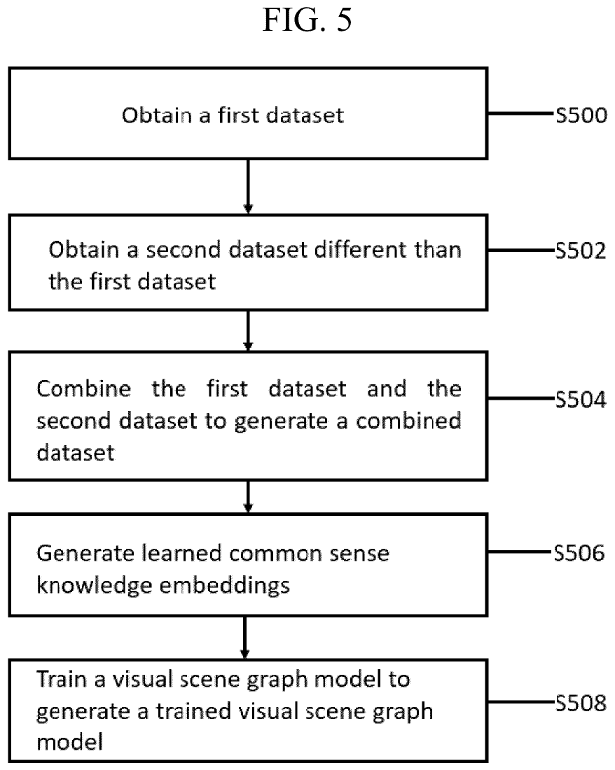

With reference to FIG. 5, according to an embodiment, a method for controlling a device to manage a visual scene graph can include obtaining, via a processor in the device, a first dataset (e.g., S500); obtaining, via the processor, a second data set different from the first dataset (e.g., S502), the second dataset including one or more of a causal relation or an intention relation; and combining, via the processor, the first dataset and the second dataset to generate a combined dataset (e.g., S504). The combined dataset can also be referred to as an enhanced dataset.

Further in this example, the method can further include applying, via the processor, a knowledge embedding function to the combined dataset to generate learned common sense knowledge embeddings (e.g., S506); and training, via the processor, a visual scene graph model based on the learned common sense knowledge embeddings to generate a trained visual scene graph model (e.g., S508).

According to an embodiment, the method can include executing a function based on an output of the trained visual scene graph model. Also, the method will be described in more detail below.

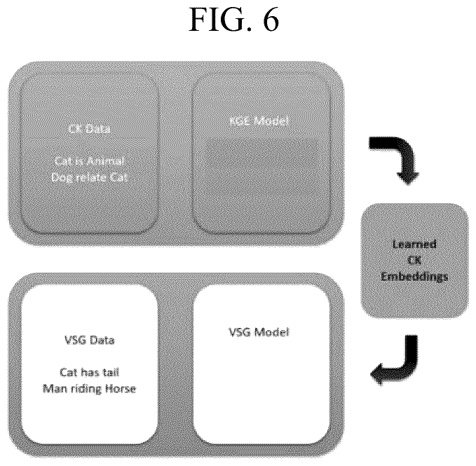

FIG. 6 illustrates a method that includes applying learned embeddings in the VSG task according to an embodiment of the present disclosure.

Visual Scene Graphs (VSGs) are a powerful tool for representing and analyzing visual scenes. However, VSGs are often biased towards classes with more training examples, leading to poor performance on classes with fewer examples, known as the long-tail problem. To address this issue, causal/intention relationships can be incorporated into the commonsense knowledge (CSK) for the VSG learning process.

For example, often VSGs rely solely on static images for representation, which lacks temporal information and hence causal/intention relations. For instance, while an image may depict an <apple-on-table>, it does not provide insights into the causal or intentional aspect, such as <X got X's car repaired, wanted, maintaining the car>. Other approaches to VSGs have only utilized basic CSK relationships, such as <cat-is-animal>, overlooking the potential of causal/intention relations for improved performance.

According to an embodiment, common sense knowledge (CSK) is augmented with causal/intention relations, creating a richer knowledge base to generate enhanced common sense knowledge (CSK). This enhanced CSK is then employed to learn an informative embedding using a graph embedding algorithm. The resulting knowledge embedding is integrated into the VSG learning process, enabling the model to capture the underlying causal and intentional relationships within visual scenes.

Further in this example, the long-tail problem in VSGs can be addressed by leveraging causal/intention relations from CSK to enhance the model's ability to generalize to classes with fewer training examples. In this way, the method can significantly improve the performance of VSGs on a variety of tasks.

With reference to FIG. 6, a method of training a VSG can include creating or collecting a first collection of CSK data (e.g., CSK triples), which can be referred to as a first dataset (e.g., Dataset 1). The first dataset can include entries, such as <cat-is-animal> and <table-on-floor>. To maintain consistency and facilitate processing, a standard format of <subject-relation-object> can be adopted for representing these triples.

In addition, the creation of the first dataset (e.g., Dataset 1) can serves various purposes. First, it can provide a baseline of general CSK relationships that form the bedrock of common-sense understanding. Also, the first dataset can establish a structured format for representing CSK triples, enabling seamless integration with subsequent datasets. Further, the first dataset can lay the groundwork for the subsequent incorporation of causal/intention relationships, for facilitating a more comprehensive and nuanced representation of CSK.

According to an embodiment, the method can further include creating or collecting a second collection of CSK data, which can be referred to as a second dataset (e.g., Dataset 2). The second dataset can include examples such as <X got X's car repaired, wanted, maintaining the car> and <X runs out of steam, causes, takes a break>. For example, the second data set can focus on causal/intentional relations. By adopting a same or similar <subject-relation-object> format as Dataset 1, Dataset 2 can be seamlessly integrated with the existing knowledge base, fostering a more comprehensive and nuanced representation of causal and intentional relationships. Thus, the first dataset and the second data set are combined to generate a combined dataset (e.g., an enhanced dataset).

In addition, the knowledge represented in a visual scene graph (VSG) often contains only simple “obvious” relations, e.g., <man-has-head> or <book-on-table>. Thus, people also normally collect similar textual knowledge, e.g., <apple-on-table>, <man-eating-pizza> to learn embeddings. Because textual knowledge can deliver a wider range of information than a visual scene graph (VSG), e.g., <farther-and-son> are not presented in VSG. Thus, this setting can be used to collect the first dataset (e.g., Dataset 1), textual commonsense knowledge which shares similar semantic relationships.

However, in contrast to the first dataset, the second dataset is used to solve or address the long-tail problem in a visual scene graph (VSG). The second dataset (e.g., Dataset 2) contains commonsense knowledge of causal/intention relations or temporal information, e.g., <car is broken—want to—repair the car>, < calling the police—want to—report a crime>. Thus, the types of knowledge in second dataset (e.g., Dataset 2) are different from the first dataset (e.g., Dataset 1). According to an embodiment, the causal/intention relation can be considered when learning an embedding for the VSG. In this way, according to an embodiment, the first dataset (e.g., Dataset 1) containing simple or obvious spatial relations can be combined with the second dataset (e.g., Dataset 2) containing the causal/intention commonsense knowledge to learn embeddings, which can better address or solve the long-tail problem in VSG.

For example, the combined dataset can broaden the spectrum of causal and intentional relationships captured within the knowledge base, enriching its overall explanatory power. Also, it augments the dataset's size, which can further enhance the performance of the graph embedding algorithm. In addition, the combined dataset introduces a diverse array of causal and intentional relationships, fostering the development of more generalizable knowledge embeddings. Incorporating the second dataset with the first dataset can further mitigate the long-tail problem by equipping the model with a broader and more comprehensive repository of causal and intentional relationships. This enhanced knowledge base can lead to improved performance on classes with fewer training examples, as the model is better equipped to discern the underlying causal and intentional patterns that may be less evident in the training data.

Further in this example, the first dataset and the second dataset can be combined because they share a same structure, and the merged dataset is shuffled to generate the a combined dataset (e.g., an enhanced dataset).

According to an embodiment, the merged data, comprising both the general CSK triples from Dataset 1 and the causal/intention CSK triples from Dataset 2, can be used CSK data. This enriched knowledge base serves as the foundation for generating embeddings that can ultimately lead to a less biased VSG model. The proposed CSK data (e.g., the combined dataset) can adhere to a triplet format, where each triplet can include a subject entity, an object entity, and a relation between them. To effectively learn CSK embeddings from this data, both the “subject” and “object” can be treated as entities. The dataset can encompass n distinct entities and r unique relation types. However, embodiments are not limited thereto.

In addition, according to an embodiment, to effectively capture the intricate relationships within the CSK data, complex vectors can be used represent both entities and relations. Each entity and relation can be represented by a complex vector of dimension K, encompassing both real and imaginary parts. The complex matrix of entities, denoted as E, includes two components: the real part ER, represented by an n by K matrix, and the imaginary part EI, also represented by an n by K matrix. Similarly, the complex matrix of relations, denoted as R, includes the real part RR, represented by an r by K matrix, and the imaginary part RI, represented by an r by K matrix. This type of representation can encode the nuances of entities and relations, enabling the learning of informative and meaningful CSK embeddings. However, embodiments are not limited thereto.

Further in this method, according to an embodiment, the role of an entity within a triplet can be encoded by employing the conjugate of its embedding. When an entity appears as a subject, such as “man” in the triplet <man-has-head>, its representation is ER(“man”)+EI(“man”). Conversely, when the entity appears as an object, as in <hand-part-of-man>, its representation is ER(“man”)—EI(“man”). This distinction between subject and object representations allows the model to capture the nuanced roles entities play in different relationships and in different contexts, enhancing the learning of informative CSK embeddings. Enforcing the subject and the object representations of the same word are conjugate.

In addition, to learn CSK embeddings from the combined dataset (e.g., CSK data), a score can be computed based on the defined complex matrices. This score, denoted as “score,” captures the semantic relationships between entities and relations within the triplets.

The score can be calculated according to the following equation:

score=<RR(relation),ER(subject),ER(object)>+<RR(relation),EI(subject),EI(object)>+<RI(relation),ER(subject),EI(object)>−<RI(relation),EI(subject),ER(object)> [Equation 1]

In the above equation 1, RR(relation) represent the real part of the embedding vector for the given relation, ER(subject) and ER(object) represent the real parts of the embedding vectors for the subject and object entities, respectively, EI(subject) and ER(object) represent the imaginary parts of the embedding vectors for the subject and object entities, respectively.

Also, according to another embodiment, one or more data sets can be applied to the KGE model to generate learned common sense knowledge embeddings. The KGE model can include one or more of TransE, RotatE, GloVe and ComplEx, and variations thereof, but embodiments are not limited thereto.

In addition, according to an embodiment, the learned CSK embedding can be obtained by applying a function (e.g., softplus) on the computed score and the corresponding ground-truth embedding. This process can adjust the embedding representation to align with the ground-truth, ensuring a meaningful and semantically consistent embedding. The resulting embedding, represented as ER, can serve as a foundation for training a VSG model. The learned ER embedding can capture the intricate relationships between entities and relations, enabling the VSG model to make more informed and accurate predictions.

Further, according to an embodiment, the learned common sense knowledge embeddings can be used to train a VSG model to generate VSG data. The VSG model can include one or more of IMP, Motif and VCTree, and variations thereof, but embodiments are not limited thereto.

According to one or more embodiments of the present disclosure, a method can include applying a knowledge embedding function to a combined dataset to generate learned common sense knowledge embeddings, and training a visual scene graph model based on the learned common sense knowledge embeddings to generate a trained visual scene graph model, in which an output of the trained visual scene graph can be used to execute or control one or more functions or actions. For example, in order to solve a technological problem, the trained visual scene graph can be used for saliency-guided object detection and avoidance (e.g., in self-driving vehicles or robots) that avoids bias and better handles rare situations, but embodiments are not limited thereto. For example, the trained visual scene graph can be used for more accurate targeted advertising and video and image compression.

Regarding self-driving vehicles or robots, the trained visual scene graph of the present disclosure can be used to more accurately analyze an image or scene to in order to detect an object or for obstacle avoidance (e.g., identify and avoid a pedestrian) that can better evaluate rare situations and reduce error rates.

According to one or more embodiments of the present disclosure, a method can include using the trained visual scene graph to solve a technological problem, such as providing more accurate automatic content recognition for a video, and visual question answering based on an image or a video which can better answer questions regarding rare cases involving the long-tail distribution.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling a device to manage a visual scene graph model, the method comprising:
obtaining, via a processor in the device, a first dataset;
obtaining, via the processor, a second data set different from the first dataset, the second dataset including one or more of a causal relation or an intention relation;
combining, via the processor, the first dataset and the second dataset to generate a combined dataset;
applying, via the processor, a knowledge embedding function to the combined dataset to generate learned common sense knowledge embeddings; and
training, via the processor, a visual scene graph model based on the learned common sense knowledge embeddings to generate a trained visual scene graph model.

2. The method of claim 1, wherein the combining includes:
merging the first dataset and the second dataset to generate a merged dataset; and
shuffling entries in the merged dataset to generate the combined dataset.

3. The method of claim 1, wherein the first dataset includes a first group of triplets having a format that includes a subject, a relation and an object, the first group of triplets indicating spatial relationships, and
wherein the second dataset includes a second group of triplets having a format that includes a subject, a relation and an object, the second group of triplets indicating causal relationships or intention relationships.

4. The method of claim 1, wherein the applying the knowledge embedding function includes:
representing both subjects and objects within the combined dataset as entities; and
representing the entities and relations as at least one complex vector,
wherein the at least one complex vector has a dimension K.

5. The method of claim 4, wherein the at least one complex vector is included in a complex matrix of entities denoted as E,
wherein the complex matrix E includes a real part ER represented by a first n by K matrix, and
wherein the complex matrix E includes an imaginary part EI represented by a second n by K matrix.

6. The method of claim 5, wherein a complex matrix of relations denoted as R includes a real part RR represented by a first r by K matrix, and
wherein the complex matrix R includes an imaginary part RI represented by a second r by K matrix.

7. The method of claim 6, wherein the applying the knowledge embedding function to the combined dataset to generate the learned common sense knowledge embeddings includes:
computing a score on the complex matrix E and the complex matrix R according to equation:
score=<RR(relation),ER(subject),ER(object)>+<RR(relation),EI(subject),EI(object)>+<RI(relation),ER(subject),EI(object)>−<RI(relation),EI(subject),ER(object)>,
wherein the RR(relation) represents a real part of an embedding vector for a given relation, the ER(subject) and the ER(object) represent real parts of embedding vectors for subject and object entities, respectively, and the EI(subject) and the ER(object) represent imaginary parts of embedding vectors for the subject and object entities, respectively.

8. The method of claim 1, wherein the first dataset and the second dataset have a same format.

9. The method of claim 1, further comprising:
executing a function based on the trained visual scene graph.

10. The method of claim 9, wherein the function includes at least one of automatic content recognition for a video, visual question answering based on an image or a video, a self-driving function, or an object detection or avoidance function.

11. The method of claim 1, wherein the device includes at least one of a smart television, a mobile phone, and a robot.

12. A device for managing a visual scene graph model, the device comprising:
a memory configured to store one or more datasets; and
a controller configured to:
obtain a first dataset,
obtain a second data set different from the first dataset, the second dataset including one or more of a causal relation or an intention relation,
combine the first dataset and the second dataset to generate a combined dataset,
apply a knowledge embedding function to the combined dataset to generate learned common sense knowledge embeddings, and
train a visual scene graph model based on the learned common sense knowledge embeddings to generate a trained visual scene graph model.

13. The device of claim 12, wherein the controller is further configured to:
merge the first dataset and the second dataset to generate a merged dataset, and
shuffle entries in the merged dataset to generate the combined dataset.

14. The device of claim 12, wherein the first dataset includes a first group of triplets having a format that includes a subject, a relation and an object, the first group of triplets indicating spatial relationships, and
wherein the second dataset includes a second group of triplets having a format that includes a subject, a relation and an object, the second group of triplets indicating causal relationships or intention relationships.

15. The device of claim 12, wherein applying the knowledge embedding function includes:
representing both subjects and objects within the combined dataset as entities, and
representing the entities and relations as at least one complex vector, and
wherein the at least one complex vector has a dimension K.

16. The device of claim 15, wherein the at least one complex vector is included in a complex matrix of entities denoted as E,
wherein the complex matrix E includes a real part ER represented by a first n by K matrix, and
wherein the complex matrix E includes an imaginary part EI represented by a second n by K matrix.

17. The device of claim 16, wherein a complex matrix of relations denoted as R includes a real part RR represented by a first r by K matrix, and
wherein the complex matrix R includes an imaginary part RI represented by a second r by K matrix.

18. The device of claim 17, wherein the controller is further configured to:
compute a score on the complex matrix E and the complex matrix R according to equation:
score=<RR(relation),ER(subject),ER(object)>+<RR(relation),EI(subject),EI(object)>+<RI(relation),ER(subject),EI(object)>−<RI(relation),EI(subject),ER(object)>,
wherein the RR(relation) represents a real part of an embedding vector for a given relation, the ER(subject) and the ER(object) represent real parts of embedding vectors for subject and object entities, respectively, and the EI(subject) and the ER(object) represent imaginary parts of embedding vectors for the subject and object entities, respectively.

19. The device of claim 12, wherein the first dataset and the second dataset have a same format.

20. The device of claim 12, wherein the controller is further configured to:
execute a function based on the trained visual scene graph.
